(19) United States
(12) Patent Application Publication
(10) Pub. No.: US 2014/0195973 A1
(43) Pub. Date: Jul. 10, 2014

(54) MOBILE DEVICE FOR PERFORMING TRIGGER-BASED OBJECT DISPLAY AND METHOD OF CONTROLLING THE SAME

(71) Applicant: Samsung Electronics Co., Ltd., Suwon-si (KR)

(72) Inventors: Sung-Joon WON, Seongnam-si (KR); Hyung-Joo JIN, Seoul (KR); Chul-Ho JANG, Seoul (KR); Hui-Chul YANG, Yongin-si (KR)

(73) Assignee: Samsung Electronics Co., Ltd., Suwon-si (KR)

(21) Appl. No.: 14/149,171

(22) Filed: Jan. 7, 2014

(30) Foreign Application Priority Data
Jan. 7, 2013 (KR) 10-2013-0001460

(51) Int. Cl. G06F 3/0482

(52) U.S. Cl. CPC G06F 3/0482
USPC 715/823

(57) ABSTRACT

A method for controlling a mobile device to perform trigger-based object display is provided. The method includes displaying a plurality of objects on a touch screen by arranging the plurality of objects on a grid with rows and columns intersecting each other, detecting a trigger occurring to at least one of the plurality of objects, and applying an emphasis effect to the at least one of the plurality of objects to which the trigger has occurred.

### PRIORITY

This application claims the benefit under 35 U.S.C. §119(a) of a Korean patent application filed on Jan. 7, 2013 in the Korean Intellectual Property Office and assigned Serial No. 10-2013-0001460, the entire disclosure of which is hereby incorporated by reference.

### BACKGROUND OF THE INVENTION

1. Field of the Invention

The present invention relates to a mobile device and a method of controlling the same. More particularly, the present invention relates to a mobile device for performing trigger-based object display and a method of controlling the same to efficiently display objects on the mobile device.

2. Description of the Related Art

Technologies for mobile devices today have advanced rapidly. More particularly, various applications can run on the mobile device to provide quite a number of services to users.

In this case, a plurality of objects may be displayed on the mobile device. For example, while a gallery application is running, a plurality of objects may be displayed that correspond to images.

It is common for the plurality of objects to be displayed in the same way. Thus, the user can only view the objects and cannot be informed of any features about respective objects.

Accordingly, a need exists for a technology of detecting at least one of a plurality of objects and placing an emphasis on the detected at least one object.

The above information is presented as background information only to assist with an understanding of the present disclosure. No determination has been made, and no assertion is made, as to whether any of the above might be applicable as prior art with regard to the present invention.

### SUMMARY OF THE INVENTION

Aspects of the present invention are to address at least the above-mentioned problems and/or disadvantages and to provide at least the advantages described below. Accordingly, an aspect of the present invention is to provide a mobile device for performing trigger-based object display and a method of controlling the same by detecting a trigger that occurs to one of a plurality of objects, by displaying the object for which the trigger has occurred, and by applying an emphasis effect to the object.

In accordance with an aspect of the present invention, a method of controlling a mobile device to perform trigger-based object display is provided. The method includes displaying a plurality of objects on a touch screen by arranging the plurality of objects on a grid with rows and columns intersecting each other, detecting a trigger occurring to at least one of the plurality of objects, and applying an emphasis effect to the at least one of the plurality of objects to which the trigger has occurred.

In accordance with another aspect of the present invention, a mobile device for performing trigger-based object display is provided. The mobile device includes a touch screen configured to display a plurality of objects by arranging the plurality of objects on a grid with rows and columns intersecting each other, and a controller configured to detect a trigger occurring to at least one of the plurality of objects, and configured to apply an emphasis effect to the at least one of the plurality of objects to which the trigger has occurred.

In accordance with another aspect of the present invention, the emphasis effect comprises at least one of expanding a size of the at least one object to which the trigger has occurred, changing color of the at least one object, applying an animation effect to the at least one object, and applying an outlining effect to the at least one object.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a schematic block diagram of a mobile device according to an exemplary embodiment of the present invention;

FIG. 2 is a front view of a mobile device according to an exemplary embodiment of the present invention;

FIG. 3 is a rear view of a mobile device according to an exemplary embodiment of the present invention;

FIG. 4 is a flowchart illustrating a method of controlling a mobile device to perform trigger-based object display according to an exemplary embodiment of the present invention;

FIGS. 5 to 9 illustrate diagrams in terms of a method of controlling a mobile device to perform trigger-based object display according to an exemplary embodiment of the present invention;

FIGS. 10 to 12 illustrate diagrams in terms of a method of controlling a mobile device to perform trigger-based object display according to an exemplary embodiment of the present invention;

FIGS. 13 to 15 illustrate diagrams in terms of a method of controlling a mobile device to perform trigger-based object display according to an exemplary embodiment of the present invention;

FIGS. 16 to 18 illustrate diagrams in terms of a method of controlling a mobile device to perform trigger-based object display according to an exemplary embodiment of the present invention;

FIGS. 19 to 21 illustrate diagrams in terms of a method of controlling a mobile device to perform trigger-based object display according to an exemplary embodiment of the present invention;

FIGS. 22 to 24 illustrate diagrams in terms of a method of controlling a mobile device to perform trigger-based object display according to an exemplary embodiment of the present invention;

FIG. 25 is a flowchart illustrating a method of controlling a mobile device to perform trigger-based object display according to an exemplary embodiment of the present invention;

FIGS. 26A to 26G illustrate diagrams in terms of a method of controlling a mobile device to perform trigger-based object display according to an exemplary embodiment of the present invention; and

FIG. 27 is a flowchart illustrating a method of controlling a mobile device to perform trigger-based object display according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a”, “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments of the present invention disclose a mobile device for performing trigger-based object display and a method of controlling the same by detecting a trigger that occurs to one of a plurality of objects, by displaying the object for which the trigger has occurred, and by applying an emphasis effect to the object.

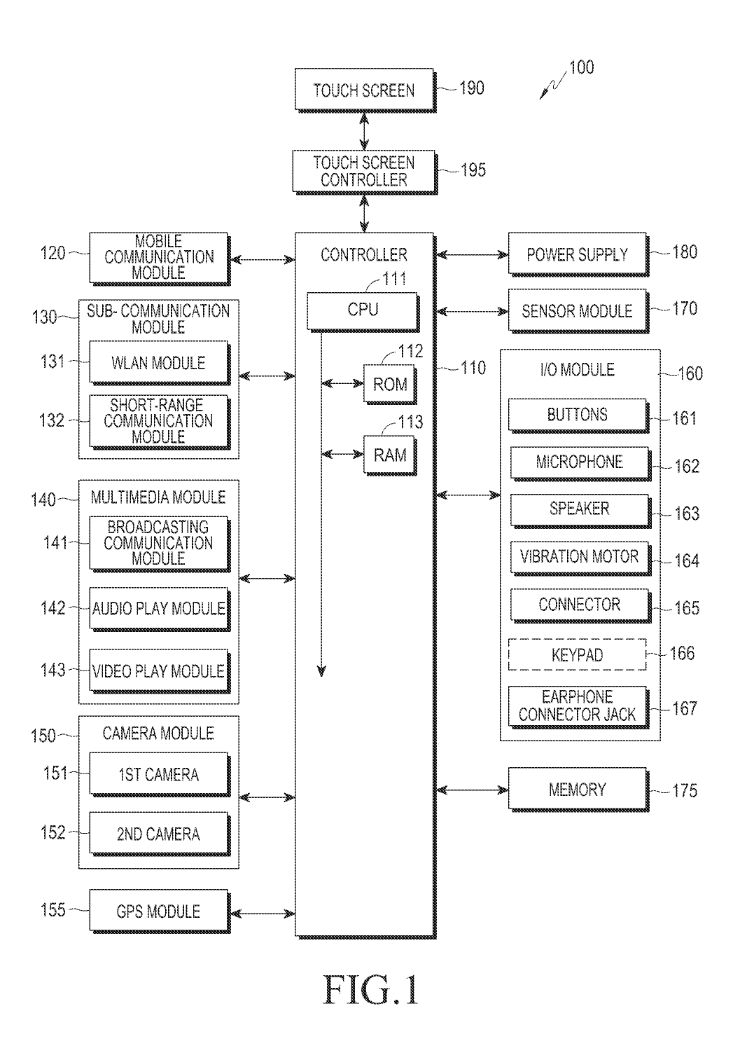

FIG. 1 is a schematic block diagram of a mobile device according to an exemplary embodiment of the present invention.

Referring to FIG. 1, a mobile device 100 (herein also referred to as an ‘apparatus’) may be connected to an external device (not shown) by using an external device connection, such as a sub-communication module 130, a connector 165, and a headset jack 167. The “external device” may include a variety of devices, such as earphones, external speakers, Universal Serial Bus (USB) memories, chargers, cradles, docking stations, Digital Multimedia Broadcasting (DMB) antennas, mobile payment related devices, health care devices (e.g., blood sugar testers), game consoles, vehicle navigations, or the like, which are removable from the mobile device 100 and connected thereto via a cable. The “external device” may also include a short range communication device that may be wirelessly connected to the mobile device 100 via short range communication, such as Bluetooth, Near Field Communication (NFC), and the like, and a WiFi Direct communication device, a wireless Access Point (AP), and the like. Furthermore, the external device may include any other device, such as a cell phone, a smartphone, a tablet Personal Computer (PC), a desktop PC, a server, and the like.

The mobile device 100 may include a touch screen 190 and a touch screen controller 195. The mobile device 100 also may include at least one of a controller 110, the mobile communication module 120, the sub-communication module 130, a multimedia module 140, a camera module 150, a Global Positioning System (GPS) module 155, an input/output module 160, a sensor module 170, a memory 175, and a power supply 180. The sub-communication module 130 may include at least one of Wireless Local Area Network (WLAN) 131 and a short-range communication module 132, and the multimedia module 140 may include at least one of a broadcast communication module 141, an audio play module 142, and video play module 143. The camera module 150 may include at least one of a first camera 151 and a second camera 152, and the input/output module 160 includes at least one of buttons 161, a microphone 162, a speaker 163, a vibration motor 164, a connector 165, a keypad 166, and a headset jack 167. Hereinafter, the touch screen 190 and the touch screen controller 195 are assumed to be, e.g., a touchscreen and a touchscreen controller, respectively.

The controller 110 may include a Central Processing Unit (CPU) 111, a Read Only Memory (ROM) 112 for storing a control program to control the mobile device 100, and a Random Access Memory (RAM) 113 for storing signals or data input from an outside or for being used as a memory space for working results in the mobile device 100. The CPU 111 may include a single core, dual cores, triple cores, or quad cores. The CPU 111, ROM 112, and RAM 113 may be connected to each other via an internal bus.

The controller 110 may control the mobile communication module 120, the sub-communication module 130, the multimedia module 140, the camera module 150, the GPS module 155, the input/output module 160, the sensor module 170, the memory 175, the power supply 180, the touch screen 190, and the touch screen controller 195.

The mobile communication module 120 connects the mobile device 100 to an external device through mobile communication using at least one-one or more antennas (not shown) under control of the controller 110. The mobile communication module 120 transmits/receives wireless signals for voice calls, video conference calls, Short Message Service (SMS) messages, or Multimedia Message Service (MMS) messages to/from a cell phone (not shown), a smart phone (not shown), a tablet PC (not shown), or another device not shown), the phones having phone numbers entered into the mobile device 100.

The sub-communication module 130 may include at least one of the WLAN module 131 and the short-range communication module 132. For example, the sub-communication module 130 may include either the WLAN module 131 or the short range communication module 132, or both.

The WLAN module 131 may be connected to the Internet in a place where there is a wireless AP (not shown), under control of the controller 110. The WLAN module 131 supports the Institute of Electrical and Electronics Engineers (IEEE's) WLAN standard IEEE802.11x. The short-range communication module 132 may conduct short-range communication between the mobile device 100 and an image rendering device (not shown) under control of the controller 110. The short-range communication may include Bluetooth, Infrared Data Association (IrDA), WiFi-Direct, Near Field Communication (NFC), and the like.

The mobile device 100 may include at least one of the mobile communication module 120, the WLAN module 131 and the short-range communication module 132 based on the performance. For example, the mobile device 100 may include a combination of the mobile communication module 120, the WLAN module 131, and the short-range communication module 132 based on the performance.

The multimedia module 140 may include the broadcast communication module 141, the audio play module 142, or the video play module 143. The broadcast communication module 141 may receive broadcast signals (e.g., television broadcast signals, radio broadcast signals, or data broadcast signals) and additional broadcast information (e.g., Electric Program Guide (EPG) or Electric Service Guide (ESG)) transmitted from a broadcasting station through a broadcast communication antenna (not shown) under control of the controller 110. The audio play module 142 may play digital audio files (e.g., files having extensions, such as Motion Pictures Expert Group (MPEG-1 or MPEG-2) Audio Layer 3 (MP3), wma, ogg, way, and the like) stored or received under control of the controller 110. The video play module 143 may play digital video files (e.g., files having extensions, such as mpeg, mpg, mp4, avi, move, or mkv) stored or received under control of the controller 110. The video play module 143 may also play digital audio files.

The multimedia module 140 may include the audio play module 142 and the video play module 143 except for the broadcast communication module 141. The audio play module 142 or video play module 143 of the multimedia module 140 may be included in the controller 110.

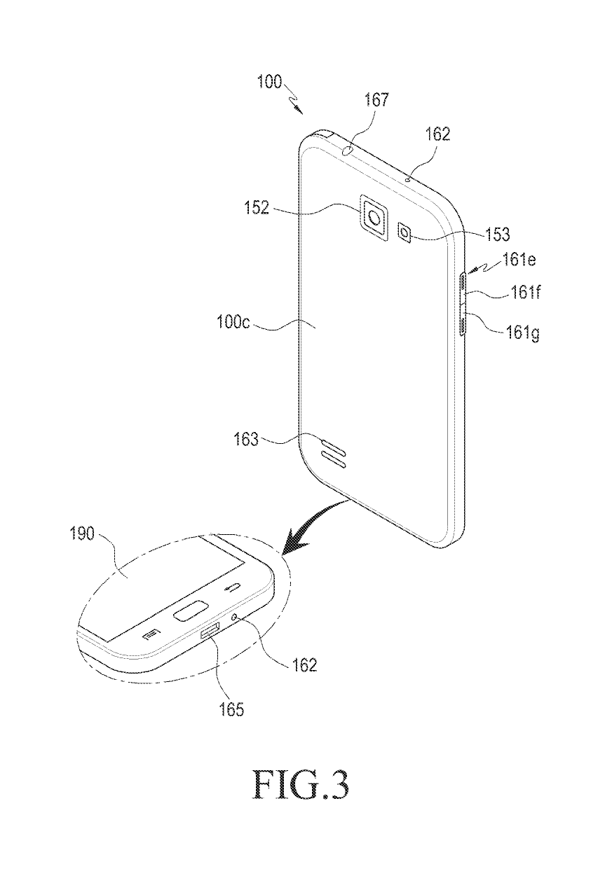

The camera module 150 may include at least one of the first and second cameras 151 and 152, respectively, for capturing still images or video images under control of the controller 110. Furthermore, the first or second camera 151 or 152 may include an auxiliary light source (e.g., a flash 153, FIG. 3) for providing as much light as required for capturing an image. The first camera 151 may be placed on the front of the mobile device 100 and the second camera 152 may be placed on the back of the mobile device 100. In another way, the first and second cameras 151 and 152, respectively, are arranged adjacent to each other (e.g., the distance between the first and second cameras 151 and 152, respectively, may be in the range between 1 to 8 cm), capturing 3 Dimensional (3D) still images or 3D video images.

The GPS module 155 may receive radio signals from a plurality of GPS satellites (not shown) in Earth's orbit, and may calculate the position of the mobile device 100 by using time of arrival from the GPS satellites to the mobile device 100.

The input/output module 160 may include at least one of a plurality of buttons 161, the microphone 162, the speaker 163, the vibrating motor 164, the connector 165, and the keypad 166.

The at least one of buttons 161 may be arranged on the front, side, or back of the housing of the mobile device 100, and may include at least one of a power/lock button, a volume button, a menu button, a home button, a back button, a search button, and the like.

The microphone 162 may generate electric signals by receiving voice or sound under control of the controller 110.

The speaker 163 may output sounds corresponding to various signals (e.g., radio signals, broadcast signals, digital audio files, digital video files or photography signals) from the mobile communication module 120, sub-communication module 130, multimedia module 140, or camera module 150 to the outside under control of the controller 110. The speaker 163 may output sounds (e.g., button-press sounds or ringback tones) that correspond to functions performed by the mobile device 100. There may be one or multiple speakers 163 arranged in a proper position or proper positions of the housing of the mobile device 100.

The vibrating motor 164 may convert an electric signal to a mechanical vibration under control of the controller 110. For example, the mobile device 100 in a vibrating mode operates the vibrating motor 164 when receiving a voice call from another device (not shown). There may be one or more vibration motors 164 inside the housing of the mobile device 100. The vibration motor 164 may operate in response to a touch activity or continuous touches of a user over the touchscreen 190.

The connector 165 may be used as an interface for connecting the mobile device 100 to the external device (not shown) or a power source (not shown). Under control of the controller 110, the mobile device 100 may transmit data stored in the memory 175 of the mobile device 100 to the external device via a cable connected to the connector 165, or receive data from the external device. The external device may be a docking station and the data may be an input signal received from the external device, e.g., a mouse, a keyboard, or the like. Furthermore, the mobile device 100 may be powered by the power source via a cable connected to the connector 165 or may charge the battery (not shown) with the power source.

The keypad 166 may receive key inputs from the user to control the mobile device 100. The keypad 166 may include a physical keypad (not shown) formed in the mobile device 100, or a virtual keypad (not shown) displayed on the touchscreen 190. The mechanical keypad formed in the mobile device 100 may be excluded depending on the performance or structure of the mobile device 100.

A headset (not shown) may be inserted into the headset jack 167 and thus connected to the mobile device 100.

The sensor module 170 may include at least one sensor for detecting a status of the mobile device 100. For example, the sensor module 170 may include a proximity sensor to detect the proximity of the user to the mobile device 100 and a light sensor to detect an ambient light level of the mobile device 100. The sensor module 170 may also include a gyro sensor. The gyro sensor may detect operations of the mobile device 100 (e.g., rotation, acceleration, or vibration of the mobile device 100), detect points of the compass using the Earth's magnetic field, and detect the direction of gravity. The sensor module 170 may also include an altimeter that detects an altitude by measuring atmospheric pressure. The at least one sensor may detect a status and generate a corresponding signal to transmit to the controller 110. The at least one sensor of the sensor module 170 may be added or removed depending on the performance of the mobile device 100.

The memory 175 may store signals or data input/output according to operations of the mobile communication module 120, the sub-communication module 130, the multimedia module 140, the camera module 150, the GPS module 155, the input/output module 160, the sensor module 170, the touch screen 190 under control of the controller 110. The memory 175 may store the control programs and applications for controlling the mobile device 100 or the controller 110.

The term “storage” implies not only to the memory 175, but also the ROM 112, RAM 113 in the controller 110, or a memory card (not shown) (e.g., a Secure Digital (SD) card, a memory stick, etc.) installed in the mobile device 100. The storage may also include a non-volatile memory, a volatile memory, a Hard Disc Drive (HDD), a Solid State Drive (SSD), and the like.

The power supply 180 may supply power to one or more batteries (not shown) placed inside the housing of the mobile device 100 under control of the controller 110. The one or more batteries power the mobile device 100. The power supply 180 may supply the mobile device 100 with the power input from the external power source (not shown) via a cable connected to the connector 165. The power supply 180 may also supply the mobile device 100 with wireless power from an external power source using a wireless charging technology.

The touchscreen 190 may provide the user with a user interface for various services (e.g., a call, a data transmission, broadcasting, photography services, and the like). The touchscreen 190 may send an analog signal corresponding to at least one touch input to the user interface to the touchscreen controller 195. The touch screen 190 may receive the at least one touch from a user's physical contact (e.g., with fingers including thumb) or via a touchable input device (e.g., a stylus pen). The touchscreen 190 may receive consecutive moves of one of the at least one touch. The touch screen 190 may send an analog signal corresponding to the consecutive moves of the input touch to the touchscreen controller 195.

Here, the touch is not limited to the user's physical contact or touchable input device but may include non-touches. The detectable distance from the touch screen 190 may vary depending on the performance or structure of the mobile device 100.

The touch screen 190 may be implemented in e.g., a resistive way, a capacitive way, an infrared way, an acoustic wave way, and the like.

The touch screen controller 195 may convert the analog signal received from the touch screen 190 to a digital signal (e.g., XY coordinates) and transmit the digital signal to the controller 110. The controller 110 may control the touch screen 190 by using the digital signal received from the touch screen controller 195. For example, in response to the touch, the controller 110 may enable a shortcut icon (not shown) displayed on the touchscreen 190 to be selected or to be executed. The touch screen controller 195 may also be incorporated in the controller 110.

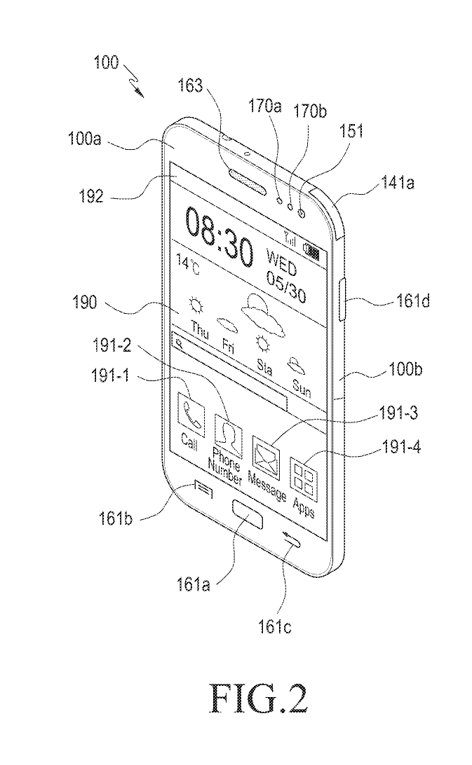

FIG. 2 is a front view of a mobile device according to an exemplary embodiment of the present invention. FIG. 3 is a rear view of a mobile device according to an exemplary embodiment of the present invention.

Referring to FIGS. 2 and 3, a front face 100a of the mobile device 100 has the touch screen 190 arranged in the center. The touch screen 190 is formed as large as it may occupy most of the front face 100a of the mobile device 100. In FIG. 2, the touch screen 190 shows an example of displaying a main home screen. The main home screen is a first screen to be displayed on the touch screen 190 when the mobile device 100 is powered on. In a case the mobile device 100 has multiple pages of different home screens, the main home screen may be the first of the home screens. In the main home screen, shortcut icons 191-1, 191-2, 191-3 for running frequently-used applications, an application key 191-4, time, weather, and the like, may be displayed. If selected, the application key 191-4 may display application icons representative of respective applications on the touch screen 190. In an upper part of the touch screen 190, there may be a status bar 192 for displaying statuses of the mobile device 100, such as a battery charging state, intensity of received signals, current time, and the like.

In a lower part of the touch screen 190, there may be a home button 161a, a menu button 161b, and a back button 161c.

When selected, the home button 161 a may display the main home screen on the touch screen 190. For example, if the home button 161a is pressed (or touched) while any home screen other than the main home screen or a menu screen is displayed in the touch screen 190, the main home screen may be displayed on the touch screen 190. Furthermore, while applications are running on the touch screen 190, if the home button 161a is pressed (or touched), the main home screen, as shown in FIG. 2, may be displayed on the touch screen 190. The home button 161a may also be used to display recently used applications or a task manager on the touch screen 190.

The menu button 161b may provide a link menu that may be used on the touch screen 190. The link menu may include a widget addition menu, a background change menu, a search menu, an edit menu, an environment setting menu, and the like. While an application is running, a menu related to the application may be provided.

The back button 161c, when touched, may display a screen that was displayed right before a current screen or stop a most recently used application.

On the edge of the front face 100a of the mobile device 100, the first camera 151, an illumination sensor 170a, and a proximity sensor 170b may be placed. On the back 100c of the mobile device 100, the second camera 152, the flash 153, and the speaker 163 may be placed.

On the side 100b of the mobile device 100, e.g., a power/reset button 161d, a volume button 161e (i.e., volume up button 161f and volume down button 161g), a terrestrial DMB antenna 141a for broadcast reception, one or more microphones 162, and the like, may be placed. The DMB antenna 141a may be fixed to the mobile device 100, or be removably arranged.

On the lower side of the mobile device 100, the connector 165 is formed. The connector 165 has a number of electrodes and may be connected to an external apparatus via a cable. On the upper side of the mobile device 100, the headset jack 167 may be formed. The headset jack 167 may have a headset inserted thereto.

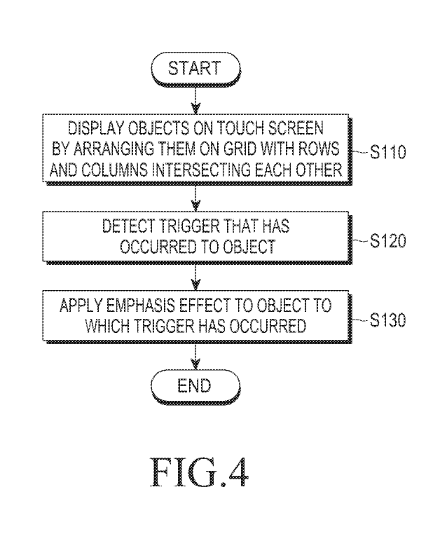

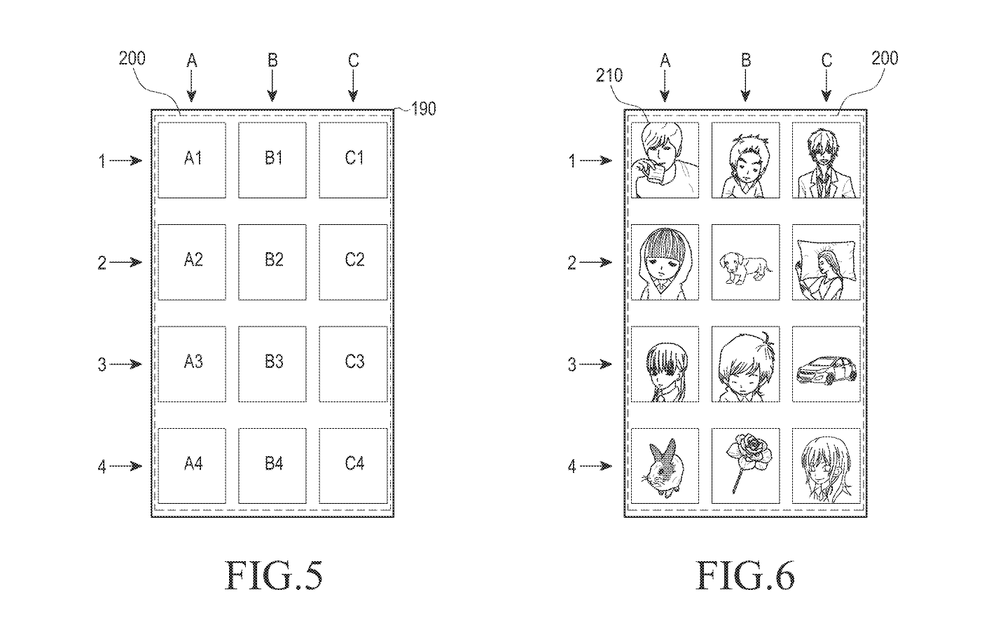

FIG. 4 is a flowchart illustrating a method of controlling a mobile device to perform trigger-based object display according to an exemplary embodiment of the present invention. FIGS. 5 to 9 illustrate diagrams in terms of a method of controlling a mobile device to perform trigger-based object display according to an exemplary embodiment of the present invention.

Referring to FIGS. 4 to 9, in the exemplary embodiment of the method of controlling the mobile device 100 to perform trigger-based object display, a plurality of objects are first displayed on the touch screen 190 as being arranged on a grid formed with rows and columns intersecting each other, at step S110. The controller 110 of the mobile device 100 displays the plurality of objects on the touch screen 190 by arranging them on the grid. The grid is formed with rows and columns passing across each other. In other words, the grid may be formed with rows and columns intersecting at right angles. For example, as shown in FIG. 5, the grid may be formed with four rows and three columns intersecting at right angles. For example, the grid may be formed with rows 1 to 4 and columns A, B, and C passing across each other at right angles.

The controller 110 may display the plurality of objects on the touch screen 190 by arranging them on the grid formed with rows and columns intersecting each other. The plurality of objects may be content including at least one of images, text, and videos. The plurality of objects may also be icons, widgets, thumbnails, or the like. For example, as shown in FIG. 5, the controller 110 may display a plurality of objects 200 on the touch screen 190 by arranging them on a grid with four rows and three columns intersecting at right angles. The plurality of objects 200 may be e.g., images. In this case, as shown in FIG. 6, the controller 110 may display the plurality of objects 200 of images on the touch screen 190 by arranging them on the grid with four rows and three columns intersecting at right angles. The controller 110 may run a gallery application and display the plurality of objects 200 of images on the touch screen 190 by arranging them on the grid with four rows and three columns intersecting at right angles.

The controller 110 may display the plurality of objects by arranging them on the grid in a predefined sequence. The predefined sequence may be, for example, from top-left to bottom-right. Referring to FIG. 6, the plurality of objects 200 are displayed on the touch screen 190 as being arranged on the grid with four rows and three columns intersecting at right angles. For example, the controller 110 may display the plurality of objects by arranging them on the grid in the sequence from top-left corresponding to cell A1 consisting of column A and row 1 to bottom-right corresponding to cell C4 consisting of column C and row 4. In other words, the controller 110 may arrange and display the plurality of objects in the sequence of cells A1, A2, A3, A4, B1, B2, B3, B4, C1, C2, C3, and C4.

The controller 110 may display the plurality of objects by arranging them on the grid in the predefined sequence based on attributes of the plurality of objects. The attributes of the plurality of objects may be points in time when the plurality of objects were stored, an alphabetical order of their titles, data types, or data sizes.

For example, the controller 110 may display the plurality of objects by arranging them on the grid in the predefined sequence based on attributes of the plurality of objects, the attributes being points in time when the plurality of objects were stored. More specifically, the controller 110 may display the plurality of objects by arranging them on the grid in the predefined sequence in which a first-stored object comes first. For example, the controller 110 may display the plurality of objects by arranging them on the grid in the predefined sequence in which a first-stored object comes first on top-left and the last-stored object comes last on bottom-right. As shown in FIG. 6, the controller 110 places and displays a first object that was stored first in a cell A1, a second object that was stored second in a cell A2, a third object that was stored third in a cell A3, a fourth object that was stored fourth in a cell A4, a fifth object that was stored fifth in a cell B1, a sixth object that was stored sixth in a cell B2, a seventh object that was stored seventh in a cell B3, an eighth object that was stored eighth in a cell B4, a ninth object that was stored ninth in a cell C1, a tenth object that was stored tenth in a cell C2, a eleventh object that was stored eleventh in a cell C3, and a twelfth object that was stored twelfth in a cell C4.

In another example, the controller 110 may display the plurality of objects by arranging them on the grid in the predefined sequence based on attributes of the plurality of objects, the attributes being an alphabetical order of titles of the plurality of objects.

In another example, the controller 110 may display the plurality of objects by arranging them on the grid in the predefined sequence based on attributes of the plurality of objects, the attributes being data types of the plurality of objects. More specifically, the controller 110 may display the plurality of objects by arranging them on the grid in the predefined sequence of e.g., in the order of video, audio, and text.

In another example, the controller 110 may display the plurality of objects by arranging them on the grid in the predefined sequence based on attributes of the plurality of objects, the attributes being data sizes of the plurality of objects. More specifically, the controller 110 may display the plurality of objects by arranging them on the grid in the predefined sequence in which an object having a bigger data size comes first.

In the meantime, a trigger that has occurred to any of the plurality of objects is detected, at step S120. In other words, the controller 110 may detect a trigger that has occurred to any of the plurality of objects. The trigger may be a map trigger, a favorites trigger, a share setting trigger, a comment write trigger, an entry path trigger, or an event trigger for any of the plurality of objects.

For example, the controller 110 may detect the map trigger that has occurred to any of the plurality of objects. More specifically, the controller 110 may have a trigger occur for any of the plurality of objects if a location where the object was captured is the same as where the mobile device 100 is at present. The trigger may be called the ‘map trigger’. The controller 110 may detect the map trigger that has occurred to any of the plurality of objects.

More specifically, the controller 110 may calculate the location of the mobile device 100 with the GPS module 155. The controller 110 may recognize where the plurality of objects were captured (e.g., geo-tags). The recognized locations where the plurality of objects was captured may be stored in the memory 175 beforehand. The controller 110 may then read any of the locations from the memory 175 and recognize where any of the plurality of objects was captured. Thereafter, the controller 110 may compare the current location of the mobile device 100 with a location where any of the plurality of objects was captured, and may have the map trigger occur for any of the plurality of objects that has the same location where it was captured as the current location of the mobile device 100. The controller 110 may detect the map trigger.

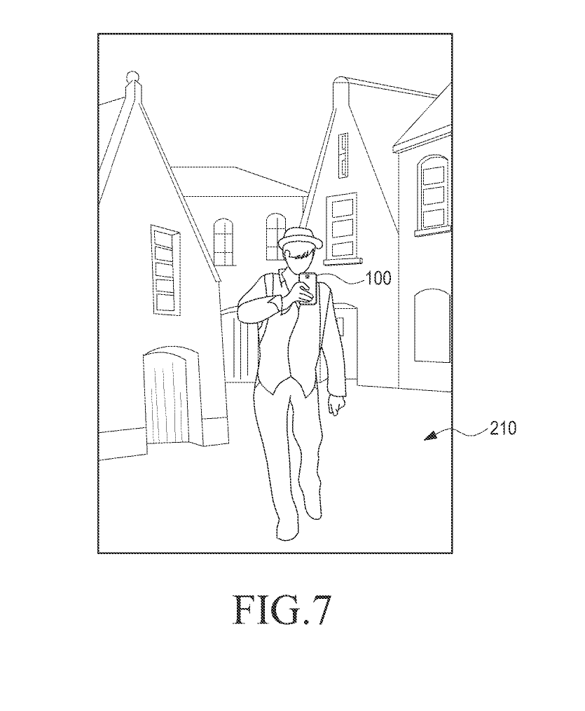

Referring to FIG. 7, for example, the controller 110 may determine that the mobile device 100 is in Paris, France with the GPS module 155. The controller 110 may recognize where any of the plurality of objects was captured (e.g., geo-tags) from the memory 175. Referring back to FIG. 6, for example, an image object 210 arranged and displayed in cell A1 was captured in Paris, France. At this time, the controller 110 may recognize that the image object 210 was captured in Paris, France by reading information that the image object 210 was captured in Paris, France from the memory 175. The controller 110 may thus have the map trigger occur for the image object 210 because the current location of the mobile device 100 is the same as the location where the image object 210 was captured, which is Paris, France. Thereafter, the controller 110 may detect the map trigger that has occurred to the image object 210.

Accordingly, the exemplary embodiment of the present invention gives an advantage of detecting a trigger that has occurred to any of a plurality of objects.

At step S130, an emphasis effect is applied to at least one object to which the trigger has occurred. The emphasis effect refers to any one of expanding the size of the at least one object, changing the color of the at least one object, and applying a predefined effect to the at least one object. The predefined effect may be an animation effect or an outlining effect. In other words, the controller 110 may display the at least one object to which the trigger has occurred by applying the emphasis effect to the at least one object. For example, the controller 110 may display the at least one object to which the trigger has occurred by expanding the size of the at least one object. In this case, the controller 110 may expand the size to occupy adjacent row and/or column.

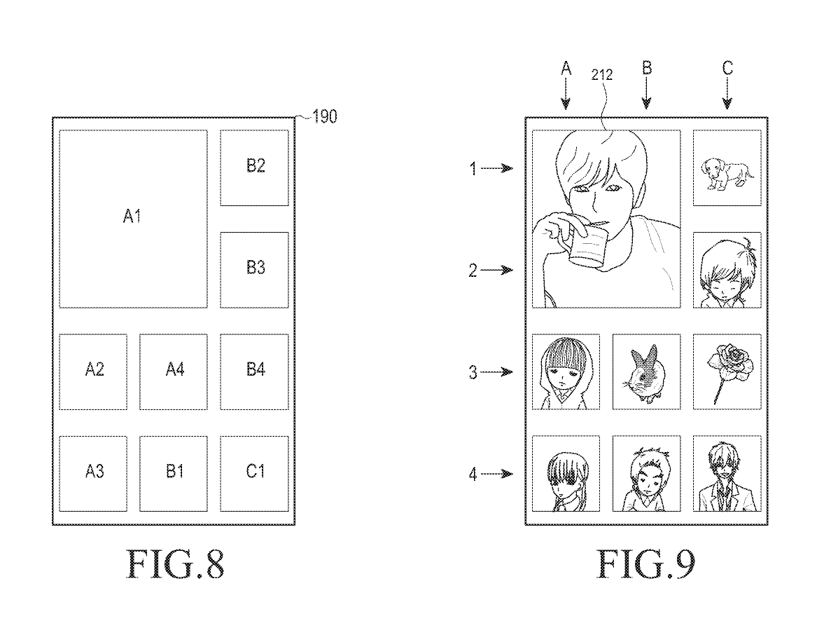

For example, if the trigger has occurred to an object arranged in cell A1 (also referred to as an object A1), the controller 110 may apply the emphasis effect to the object A1 by expanding its size as shown in FIG. 8. In this case, the controller 110 may expand the size of the object A1 to occupy adjacent row and/or column. More specifically, for example, the controller 110 may expand the size of the object A1 to occupy next row 2 and/or column B, resulting in cells A1, A2, B1, and B2 as shown in FIG. 8.

Referring back to FIG. 6, for example, if the map trigger that has occurred to the image object 210 is detected at step S120, the controller 110 may apply the emphasis effect to the image object 210 in cell A1 and display the result as shown in FIG. 9. For example, the controller 110 may expand the size of the image object 212 in cell A1, as shown in FIG. 9. More specifically, for example, the controller 110 may expand the size of the image object 212 to occupy next row 2 and/or column B, resulting in cells A1, A2, B1, and B2, as shown in FIG. 9.

Thus, the emphasis effect may be applied to at least one object to which a trigger has occurred.

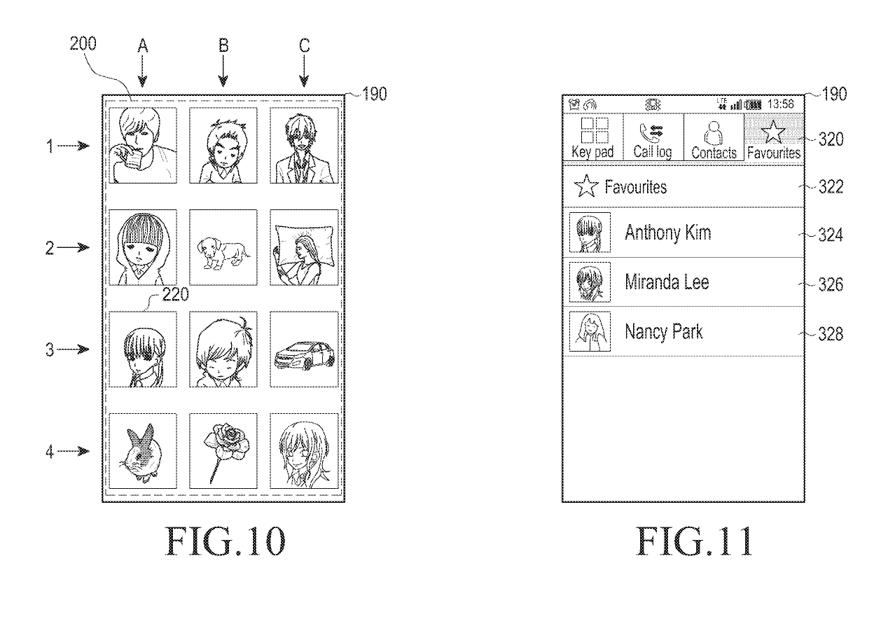

FIGS. 10 to 12 illustrate diagrams in terms of a method of controlling a mobile device to perform trigger-based object display according to an exemplary embodiment of the present invention.

Referring back to FIG. 4, in the exemplary embodiment of the method of controlling the mobile device 100 to perform trigger-based object display, a plurality of objects are first displayed on the touch screen 190 as being arranged on a grid formed with rows and columns intersecting each other, at step S110.

Referring to FIGS. 10 to 12, the controller 110 of the mobile device 100 displays the plurality of objects on the touch screen 190 by arranging them on the grid. The plurality of objects may be content including at least one of images, text, and videos. The plurality of objects may also be icons, widgets, thumbnails, or the like. For example, as shown in FIG. 10, the controller 110 may display the plurality of objects 200 on the touch screen 190 by arranging them on a grid with four rows and three columns intersecting at right angles. The plurality of objects 200 may be e.g., images.

A trigger that has occurred to any of the plurality of objects is detected, at step S120. For example, the controller 110 detects a trigger that has occurred to any of the plurality of objects. The trigger may be a map trigger, a favorites trigger, a share setting trigger, a comment write trigger, an entry path trigger, or an event trigger for any of the plurality of objects.

For example, the controller 110 may detect a favorites trigger that has occurred to any of the plurality of objects. More specifically, the controller 110 may have a trigger occur for any of the plurality of objects if the object has been registered to the Favorites 320 of FIG. 11 of the user of the mobile device 100. The trigger may be called the ‘favorites trigger’. The controller 110 may detect the favorites trigger that has occurred to any of the plurality of objects.

Specifically, the controller 110 may extract a contact registered to the Favorites 320. The contact may be stored in the memory 175 beforehand. Thus, the controller 110 may extract the contact registered to the Favorites from the storage 157. Thereafter, the controller 110 may have the favorites trigger occur for any of the plurality of objects that has a title the same as a contact registered to the Favorites 322 of FIG. 11. The controller 110 may detect the favorites trigger that has occurred to any of the plurality of objects.

For example, the controller 110 may display a list of contacts registered to the Favorites 322 stored in the memory 175 beforehand on the touch screen 190, as shown in FIG. 11. In FIG. 11, exemplary contacts registered to the Favorites 322 are Anthony Kim 324, Miranda Lee 326, and Nancy Park 328. Among the objects 200 of FIG. 10, one in cell A3 220 has a title the same as one of contacts 324, 326, and 328 registered to the Favorites 322 shown in FIG. 11. Thereafter, the controller 110 may have the favorites trigger occur for the object 220 in cell A3 and may detect the favorites trigger that has occurred to the image object 220.

Accordingly, the exemplary embodiment of the present invention gives an advantage of detecting the favorites trigger that has occurred to any of a plurality of objects.

At step S130, an emphasis effect is applied to at least one object to which the trigger has occurred. The emphasis effect refers to any one of expanding the size of the at least one object, changing the color of the at least one object, and applying a predefined effect to the at least one object. In other words, the controller 110 may display the at least one object to which the trigger has occurred, which is detected at step S120, by applying the emphasis effect to the at least one object. For example, the controller 110 may display the at least one object to which the trigger has occurred by expanding the size of the at least one object. In this case, the controller 110 may expand the size to occupy an adjacent row and/or column.

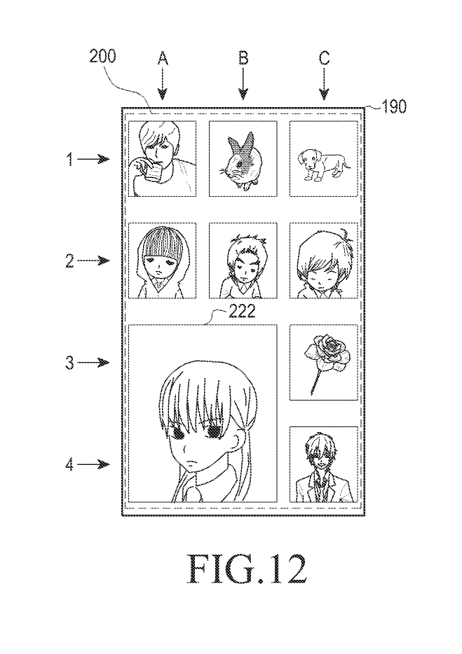

Referring back to FIG. 10, for example, if the favorites trigger that has occurred to the image object 220 in cell A3 is detected at step S120, the controller 110 may apply the emphasis effect to the image object 220 and display the result as shown in FIG. 12. For example, the controller 110 may expand the size of the image object 220 in cell A3, as shown in FIG. 12. More specifically, for example, the controller 110 may expand the size of the image object 220 to occupy next row 4 and/or column B, resulting in cells A3, A4, B3, and B4, as shown in FIG. 12.

Thus, the emphasis effect may be applied to at least one object to which the favorites trigger has occurred.

FIGS. 13 to 15 illustrate diagrams in terms of a method of controlling a mobile device to perform trigger-based object display according to an exemplary embodiment of the present invention.

Referring back to FIG. 4, in the exemplary embodiment of the method of controlling the mobile device 100 to perform trigger-based object display, a plurality of objects are first displayed on the touch screen 190 as being arranged on a grid formed with rows and columns intersecting each other, at step S110.

Referring to FIGS. 13 to 15, the controller 110 of the mobile device 100 displays the plurality of objects on the touch screen 190 by arranging them on the grid. The plurality of objects may be content including at least one of images, text, and videos. The plurality of objects may also be icons, widgets, thumbnails, or the like. For example, as shown in FIG. 13, the controller 110 may display the plurality of objects 200 on the touch screen 190 by arranging them on a grid with four rows and three columns intersecting at right angles. The plurality of objects 200 may be e.g., images.

A trigger that has occurred to any of the plurality of objects is detected, at step S120. For example, the controller 110 detects a trigger that has occurred to any of the plurality of objects. The trigger may be a map trigger, a favorites trigger, a share setting trigger, a comment write trigger, an entry path trigger, or an event trigger for any of the plurality of objects.

For example, the controller 110 may detect a share-setting trigger that has occurred to any of the plurality of objects. More specifically, the controller 110 may have a trigger occur for any of the plurality of objects if the object has been set to be shared. The trigger may be called the ‘share-setting trigger’. The controller 110 may detect the share-setting trigger that has occurred to any of the plurality of objects.

For example, the controller 110 may detect that any of the plurality of objects is set to be shared by detecting a touch input on a share-setting icon for the object. The controller 110 may have the share-setting trigger occur for the object set to be shared. The controller 110 may then detect the share-setting trigger that has occurred to the object.

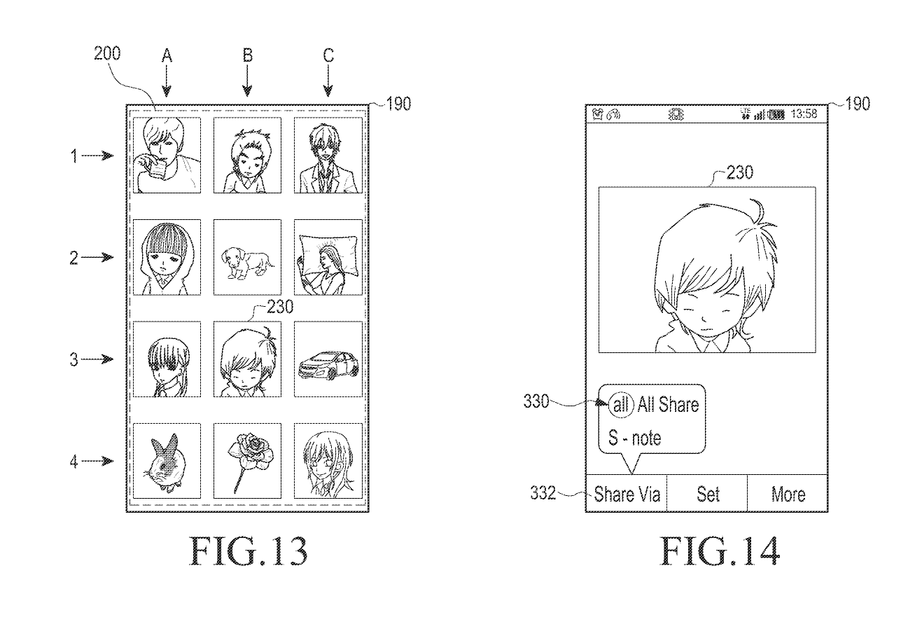

For example, the controller 110 may represent the share-setting icon 330 to be included in a specific setting tab 332 for any of the plurality of objects. The controller 110 may then detect that any of the plurality of objects is set to be shared by detecting a touch input (or selection) on the share-setting icon 330 for the object. In FIG. 14, an object arranged in cell B3 of FIG. 13 is displayed on the touch screen 190. The controller 110 may detect that the object B3 is set to be shared by detecting a touch input on the share-setting icon 330. The controller 110 may have the share-setting trigger occur for the object B3 set to be shared. The controller 110 may then detect the share-setting trigger that has occurred to the object B3.

Accordingly, the exemplary embodiment of the present invention gives an advantage of detecting the share-setting trigger occurred to any of a plurality of objects.

At step S130, an emphasis effect is applied to at least one object to which the trigger has occurred. The emphasis effect refers to any one of expanding the size of the at least one object, changing the color of the at least one object, and applying a predefined effect to the at least one object. In other words, the controller 110 may display the at least one object to which the trigger has occurred, which is detected at step S120, by applying the emphasis effect to the at least one object. For example, the controller 110 may display the at least one object to which the trigger has occurred by expanding the size of the at least one object. In this case, the controller 110 may expand the size to occupy an adjacent row and/or column.

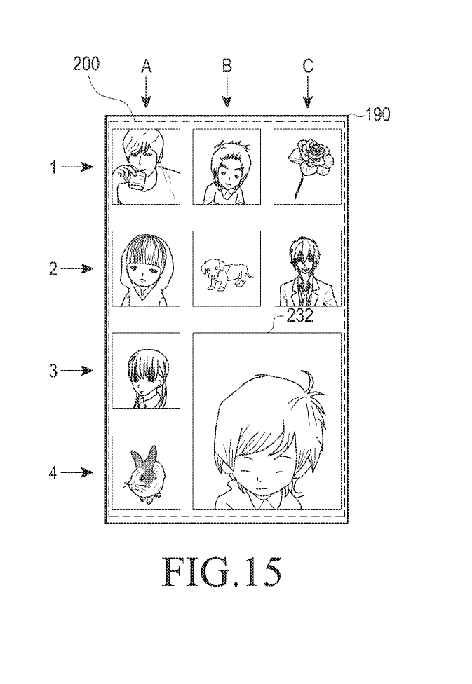

Referring back to FIG. 13, for example, if the share-setting trigger that has occurred to the image object 230 in cell B3 is detected at step S120, the controller 110 may apply the emphasis effect to the image object 230 and display the result as shown in FIG. 15. For example, the controller 110 may expand the size of the image object 230 in cell B3, as shown in FIG. 15. More specifically, for example, the controller 110 may expand the size of the image object 230 to occupy next row 4 and/or column C, resulting in cells B3, B4, C3, and C4 as shown in FIG. 15.

Thus, the emphasis effect may be applied to at least one object to which the share-setting trigger has occurred.

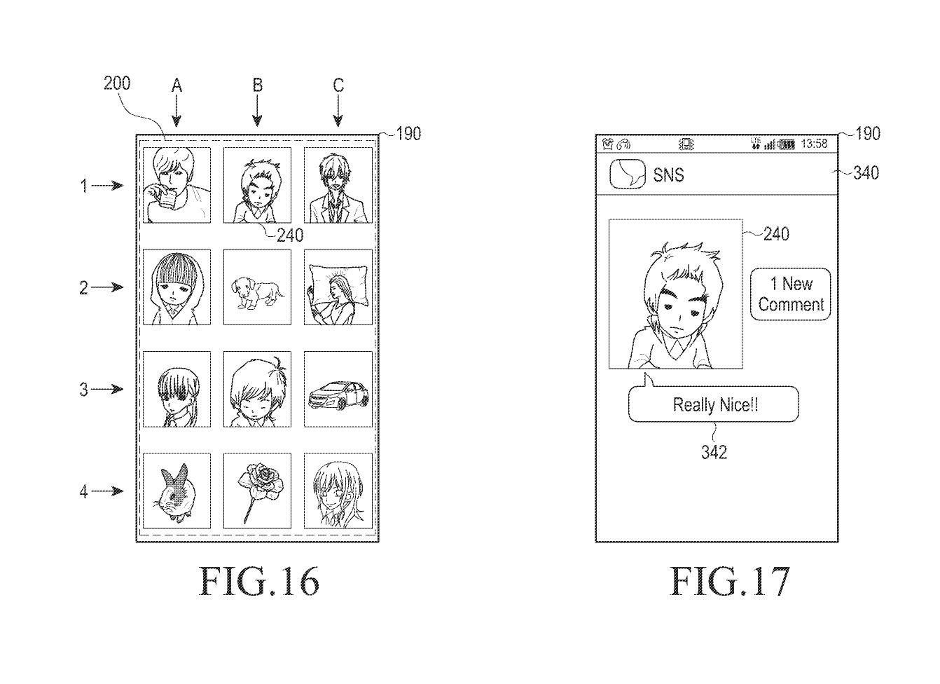

FIGS. 16 to 18 illustrate diagrams in terms of a method of controlling a mobile device to perform trigger-based object display according to an exemplary embodiment of the present invention.

Referring back to FIG. 4, in the exemplary embodiment of the method of controlling the mobile device 100 to perform trigger-based object display, a plurality of objects are first displayed on the touch screen 190 as being arranged on a grid formed with rows and columns intersecting each other, at step S110.

Referring to FIGS. 16 to 18, the controller 110 of the mobile device 100 may display the plurality of objects on the touch screen 190 by arranging them on the grid. The plurality of objects may be content including at least one of images, text, and videos. The plurality of objects may also be icons, widgets, thumbnails, or the like. For example, as shown in FIG. 16, the controller 110 may display the plurality of objects 200 on the touch screen 190 by arranging them on a grid with four rows and three columns intersecting at right angles. The plurality of objects 200 may be e.g., images.

A trigger that has occurred to any of the plurality of objects is detected, at step S120. In other words, the controller 110 may detect a trigger that has occurred to any of the plurality of objects. The trigger may be a map trigger, a favorites trigger, a share setting trigger, a comment write trigger, an entry path trigger, or an event trigger for any of the plurality of objects.

For example, the controller 110 may detect a comment write trigger that has occurred to any of the plurality of objects. More specifically, the controller 110 may have a trigger occur for any of the plurality of objects if a comment is written for the object. The trigger may be called the ‘comment write trigger’. The controller 110 may detect the comment write trigger that has occurred to any of the plurality of objects.

For example, the controller 110 may detect that a comment is written for any of the plurality of objects by detecting a comment input to the object. The controller 110 may have the comment write trigger occur for the object for which a comment is written. The controller 110 may detect the comment write trigger that has occurred to the object.

For example, the controller 110 may detect the comment input 342 to any of the plurality of objects, as shown in FIG. 17. In FIG. 17, an object 240 arranged in cell B1 of FIG. 16 is displayed on the touch screen 190. The controller 110 may detect that a comment 340 is written for the object 240 in cell B1 by detecting the comment input 342, such as “Really Nice!!”. The controller 110 may have the comment write trigger occur to the object 240 for which the comment 340 is written. The controller 110 may then detect the comment write trigger that has occurred to the object 240 in cell B1.

Accordingly, the exemplary embodiment of the present invention gives an advantage of detecting the comment write trigger for any of a plurality of objects.

At step S130, an emphasis effect is applied to at least one object to which the trigger has occurred. The emphasis effect refers to any one of expanding the size of the at least one object, changing the color of the at least one object, applying a predefined effect to the at least one object, and the like. In other words, the controller 110 may display the at least one object to which the trigger has occurred, which is detected at step S120, by applying the emphasis effect to the at least one object. For example, the controller 110 may display the at least one object to which the trigger has occurred by expanding the size of the at least one object. In this case, the controller 110 may expand the size to occupy an adjacent row and/or column.

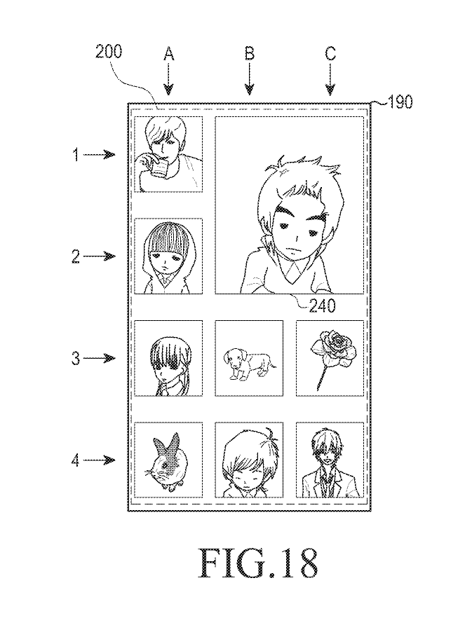

Referring back to FIG. 16, for example, if the comment write trigger that has occurred to the image object 240 in cell B1 is detected at step S120, the controller 110 may apply the emphasis effect to the image object 240 and display the result as shown in FIG. 18. For example, the controller 110 may expand the size of the image object 240 in cell B1, as shown in FIG. 18. More specifically, for example, the controller 110 may expand the size of the image object 240 to occupy next row 2 and/or column C, resulting in cells B1, B2, C1, and C2 as shown in FIG. 18.

Thus, the emphasis effect may be applied to at least one object to which the comment write trigger has occurred.

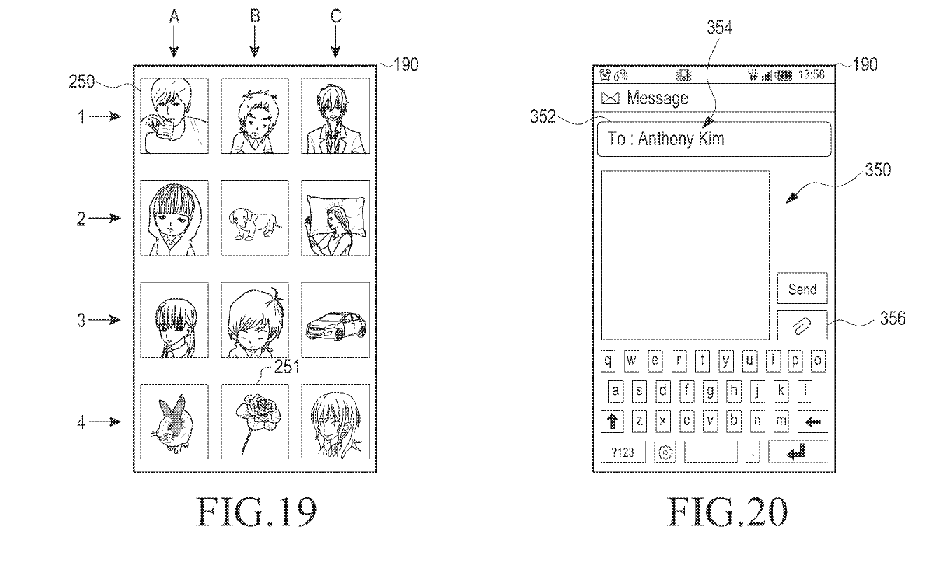

FIGS. 19 to 21 illustrate diagrams in terms of a method of controlling a mobile device to perform trigger-based object display according to an exemplary embodiment of the present invention.

Referring back to FIG. 4, in the exemplary embodiment of the method of controlling the mobile device 100 to perform trigger-based object display, a plurality of objects are first displayed on the touch screen 190 as being arranged on a grid formed with rows and columns intersecting each other, at step S110.

Referring to FIGS. 19 to 21, the controller 110 of the mobile device 100 may display the plurality of objects on the touch screen 190 by arranging them on the grid. The plurality of objects may be content including at least one of images, text, and videos. The plurality of objects may also be icons, widgets, thumbnails, or the like. For example, as shown in FIG. 19, the controller 110 may display the plurality of objects 200 on the touch screen 190 by arranging them on a grid with four rows and three columns intersecting at right angles. The plurality of objects 200 may be e.g., images.

A trigger that has occurred to any of the plurality of objects is detected, at step S120. In other words, the controller 110 may detect a trigger that has occurred to any of the plurality of objects. The trigger may be a map trigger, a favorites trigger, a share setting trigger, a comment write trigger, an entry path trigger, or an event trigger for any of the plurality of objects.

For example, the controller 110 may detect the entry path trigger that has occurred to any of the plurality of objects. More specifically, the controller 110 may have a trigger occur for any of the plurality of objects if the object is related to an entry path. The trigger may be called the ‘entry path trigger’. The controller 110 may detect the entry path trigger that has occurred to any of the plurality of objects.

More specifically, the controller 110 may extract an associated item in the entry path. Thereafter, the controller 110 may have the entry path trigger occur for any of the plurality of objects that has a title the same as an associated item in the entry path. The controller 110 may detect the entry path trigger that has occurred to any of the plurality of objects. The entry path may be a running application. Thereafter, the controller 110 may have the entry path trigger occur for any of the plurality of objects that has a title the same as an associated item in a currently running application.

For example, the controller 110 may run a message application 350 and display the running message application on the touch screen 190. The entry path may be the running message application 350, wherein an object may be attached using element 356. Thus, the associated item in the entry path may be an item related to the running message application 350. For example, the associated item in the entry path may be a name 354 of a recipient 352 of the message application 350. The controller 110 may extract the name 354 of the recipient 352 of the message application 350 as ‘Anthony Kim’ The name 354 of the recipient 352 of the message application 350, which is Anthony Kim, may be the same as the titles of image objects 250 and 251 arranged in cells A1 and B4, respectively, shown in FIG. 19. The controller 110 may then have entry path triggers occur for the image objects 250 and 251 arranged in cells A1 and B4, respectively. Thereafter, the controller 110 may detect the entry path triggers that have occurred to the image objects 250 and 251.

Accordingly, the exemplary embodiment of the present invention gives an advantage of detecting the entry path trigger occurred to any of a plurality of objects.

At step S130, an emphasis effect is applied to at least one object for which the trigger has occurred. The emphasis effect refers to expanding the size of the at least one object, changing the color of the at least one object, or applying a predefined effect to the at least one object. In other words, the controller 110 may display the at least one object to which the trigger has occurred, which is detected at step S120, by applying the emphasis effect to the at least one object. For example, the controller 110 may display the at least one object to which the trigger has occurred by expanding the size of the at least one object. In this case, the controller 110 may expand the size to occupy an adjacent row and/or column.

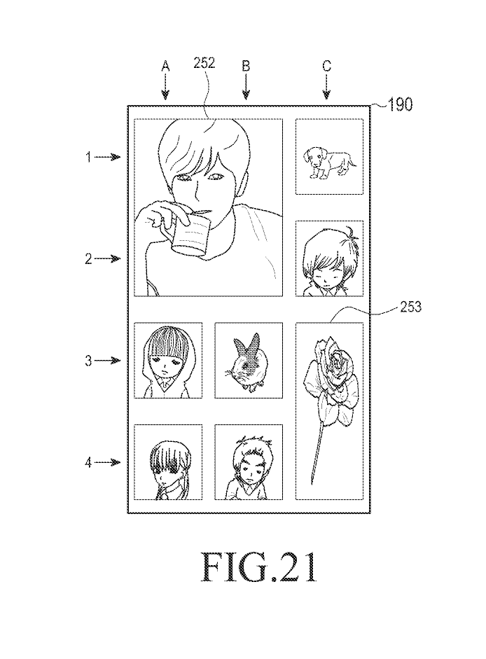

Referring back to FIG. 19, for example, if the entry path triggers that have occurred to the image object 250 in cell A1 and the image object 251 in cell B4 are detected at step S120, the controller 110 may apply the emphasis effect to the image objects 250 and 251 and display the results as shown in FIG. 21. For example, the controller 110 may expand the sizes of the image objects 250 and 251 in cells A1 and B4, respectively, as shown in FIG. 21. The controller 110 may expand the size of the image object 250 to an expanded image object 252 in cell A1 to occupy next row 2 and next column B, resulting in cells A1, A2, B1, and B2. Similarly, the controller 110 may expand the size of the image object 251 to an expanded image object 253 in cell B4 to occupy a previous row 3, resulting in cells B3 and B4, as shown in FIG. 21.

Thus, the emphasis effect may be applied to at least one object to which the entry path trigger has occurred.

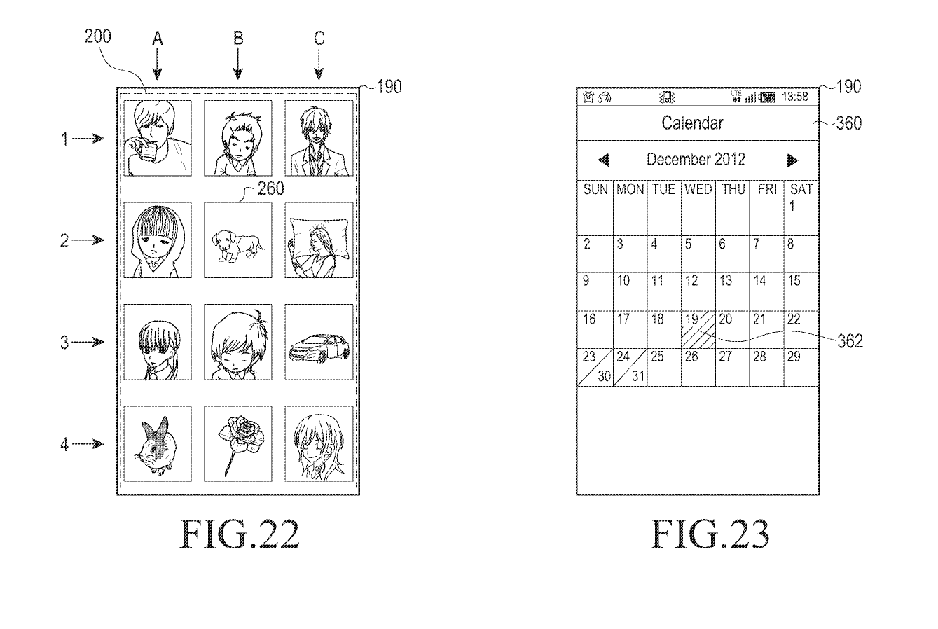

FIGS. 22 to 24 illustrate diagrams in terms of a method of controlling a mobile device to perform trigger-based object display according to an exemplary embodiment of the present invention.

Referring back to FIG. 4, in the exemplary embodiment of the method of controlling the mobile device 100 to perform trigger-based object display, a plurality of objects may be first displayed on the touch screen 190 as being arranged on a grid formed with rows and columns intersecting each other, at step S110.

Referring to FIGS. 22 to 24, the controller 110 of the mobile device 100 may display the plurality of objects on the touch screen 190 by arranging them on the grid. The plurality of objects may be content including at least one of images, text, and videos. The plurality of objects may also be icons, widgets, thumbnails, or the like. For example, as shown in FIG. 22, the controller 110 may display the plurality of objects 200 on the touch screen 190 by arranging them on a grid with four rows and three columns intersecting at right angles. The plurality of objects 200 may be e.g., images.

A trigger that has occurred to any of the plurality of objects is detected, at step S120. For example, the controller 110 may detect a trigger that has occurred to any of the plurality of objects. The trigger may be a map trigger, a favorites trigger, a share setting trigger, a comment write trigger, an entry path trigger, or an event trigger for any of the plurality of objects.

For example, the controller 110 may detect the event trigger that has occurred to any of the plurality of objects. More specifically, the controller 110 may have a trigger occur for any of the plurality of objects if an event has been registered for the object. The trigger may be called the ‘event trigger’. The controller 110 may detect the event trigger that has occurred to any of the plurality of objects.

For example, the controller 110 may detect that an event is registered for any of the plurality of objects by detecting an event input to the object. The controller 110 may have the event trigger occur for the object for which the event has been registered. The controller 110 may detect the event trigger that has occurred to any of the plurality of objects.

For example, the controller 110 may detect input of an event 362 for any of the plurality of objects, as shown in FIG. 23. More specifically, the controller 110 may run a calendar application 360 and detect that the event 362 is scheduled for a specific date. Here, the controller 110 may detect that the event 362 is scheduled for Dec. 19, 2012. The controller 110 may also detect that an object 260 arranged in cell B2 in FIG. 22 is registered to the event 362. For example, the controller 110 may detect that the object 260 arranged in cell B2 in FIG. 22 is registered to the event 362 of Dec. 19, 2012. The controller 110 may have the event trigger occur to the object 260 that has been registered to the event. Thereafter, the controller 110 may detect the event trigger that has occurred to the object 260.

Accordingly, the exemplary embodiment of the present invention gives an advantage of detecting the event trigger for any of a plurality of objects.

At step S130, an emphasis effect is applied to at least one object for which the trigger has occurred. The emphasis effect refers to any one of expanding the size of the at least one object, changing the color of the at least one object, and applying a predefined effect to the at least one object. In other words, the controller 110 may display the at least one object to which the trigger has occurred, which is detected at step S120, by applying the emphasis effect to the at least one object. For example, the controller 110 may display the at least one object to which the trigger has occurred by expanding the size of the at least one object. In this case, the controller 110 may expand the size to occupy an adjacent row and/or column.

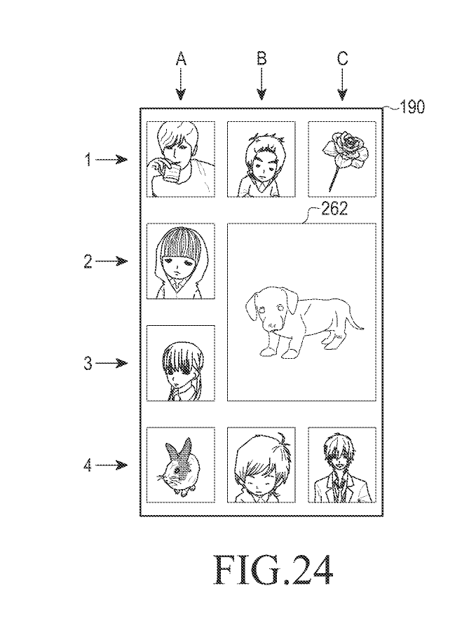

Referring back to FIG. 22, for example, if the event trigger that has occurred to the image object 260 in cell B2 is detected at step S120, the controller 110 may apply the emphasis effect to the image object 260 and display the result as shown in FIG. 24. For example, the controller 110 may expand the size of the image object 260 to an expanded image object 262 in cell B2, as shown in FIG. 24. More specifically, for example, the controller 110 may expand the size of the image object 260 to occupy next row 3 and/or column C, resulting in cells B2, B3, C2, and C3 as shown in FIG. 24.

Thus, the emphasis effect may be applied to at least one object to which the event trigger has occurred.

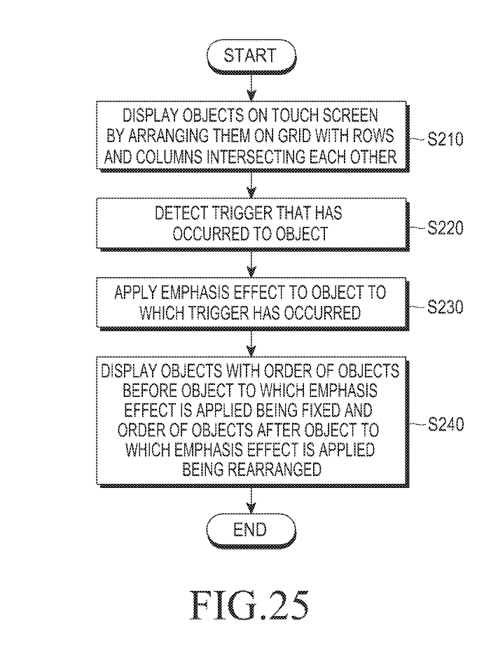

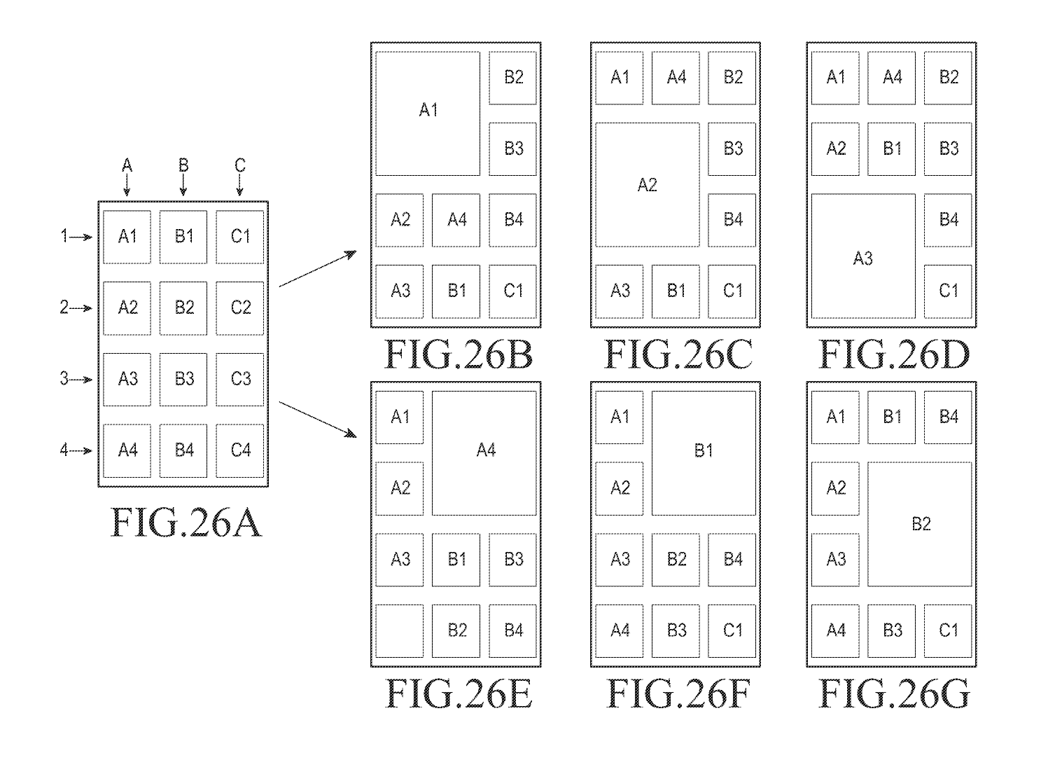

FIG. 25 is a flowchart illustrating a method of controlling a mobile device to perform trigger-based object display according to an exemplary embodiment of the present invention. FIGS. 26A to 26G illustrate diagrams in terms of a method of controlling a mobile device to perform trigger-based object display according to an exemplary embodiment of the present invention.

Referring to FIGS. 25 to 26G, in the exemplary embodiment of the method of controlling the mobile device 100 to perform trigger-based object display, a plurality of objects are first displayed on the touch screen 190 as being arranged on a grid formed with rows and columns, at step S210. The controller 110 of the mobile device 100 may display the plurality of objects on the touch screen 190 by arranging them on the grid. The grid is formed with rows and columns passing across each other. At this time, the grid may be formed with rows and columns intersecting at right angles. For example, as shown in FIG. 26A, the grid may be formed with four rows and three columns intersecting at right angles. For example, the grid may be formed with rows 1 to 4 and columns A, B, and C passing across each other at right angles.

The controller 110 may display the plurality of objects on the touch screen 190 by arranging them on the grid formed with rows and columns intersecting each other. The plurality of objects may be content including at least one of images, text, and videos. The plurality of objects may also be icons, widgets, thumbnails, or the like. For example, as shown in FIG. 26A, the controller 110 may display the plurality of objects 200 on the touch screen 190 by arranging them on a grid with four rows and three columns intersecting each other at right angles. The plurality of objects 200 may be e.g., images. In this case, as shown in FIG. 26A, the controller 110 may display the plurality of objects 200 of images on the touch screen 190 by arranging them on the grid with four rows and three columns intersecting at right angles. The controller 110 may run a gallery application and display the plurality of objects 200 of images on the touch screen 190 by arranging them on the grid with four rows and three columns intersecting at right angles.

The controller 110 may display the plurality of objects by arranging them on the grid in a predefined sequence, for example, from top-left to bottom-right. Referring to FIG. 26A, the plurality of objects 200 may be displayed on the touch screen 190 as being arranged on the grid with four rows and three columns intersecting at right angles. For example, the controller 110 may display the plurality of objects by arranging them on the grid in the sequence from top-left corresponding to cell A1 consisting of column A and row 1 to bottom-right corresponding to cell C4 consisting of column C and row 4. In other words, the controller 110 may arrange and display the plurality of objects in the sequence of A1, A2, A3, A4, B1, B2, B3, B4, C1, C2, C3, and C4.

A trigger that has occurred to any of the plurality of objects is detected, at step S220. For example, the controller 110 may detect a trigger that has occurred to any of the plurality of objects. The trigger may be a map trigger, a favorites trigger, a share setting trigger, a comment write trigger, an entry path trigger, or an event trigger for any of the plurality of objects.

At step S230, an emphasis effect is applied to at least one object for which the trigger has occurred. The emphasis effect refers to any one of expanding the size of the at least one object, changing the color of the at least one object, and applying a predefined effect to the at least one object. In other words, the controller 110 may display the at least one object to which the trigger has occurred, which is detected at step S220, by applying the emphasis effect to the at least one object. For example, the controller 110 may display the at least one object to which the trigger has occurred by expanding the size of the at least one object. In this case, the controller 110 may expand the size to occupy an adjacent row and/or column.

For example, if the trigger has occurred to an object arranged in cell A1, the controller 110 may apply the emphasis effect to the object in cell A1 by expanding its size as shown in FIG. 26B. In this case, the controller 110 may expand the size of the object in cell A1 to occupy an adjacent row and/or column. More specifically, for example, the controller 110 may expand the size of the object in cell A1 to occupy next row 2 and/or column B, resulting in cells A1, A2, B1, and B2 as shown in FIG. 26B.

At step S240, a plurality of objects may be displayed with order of objects before at least one object to which an emphasis effect is applied being fixed and order of objects after the at least one object to which the emphasis effect is applied being rearranged. In other words, the controller 110 may display a plurality of objects by fixing order of objects before at least one object to which an emphasis effect is applied and rearranging order of objects after the at least one object to which the emphasis effect is applied.

For example, in FIG. 26C, the at least one object to which an emphasis effect is applied is an object arranged in cell A2. The object of A2 is expanded in size to occupy adjacent row 3 and column B, at step S230. Thus, the controller 110 may fix the order of objects arranged before the object of A2 to which the emphasis effect is applied. For example, the controller 110 may fix the order of the object of A1 arranged before the object of A2, as shown in FIG. 26C. The controller 110 then rearranges objects arranged after the object of A2 to which the emphasis effect is applied. For example, the controller 110 may rearrange objects of A3 to C1 arranged after the object of A2. More specifically, as shown in FIG. 26C, the controller 110 may rearrange the objects of A3 to C1 by shifting an object of A3 to A4, A4 to B1, B1 to B4, B2 to C1, B3 to C2, B4 to C3, and C1 to C4.

In another example, as shown in FIG. 26D, the at least one object to which the emphasis effect is applied is an object arranged in cell A3. The object of A3 is expanded in size to occupy adjacent row 4 and column B, at step S230. Thus, the controller 110 may fix the order of objects arranged before the object of A3 to which the emphasis effect is applied. For example, the controller 110 may fix the order of objects of A1 and A2 arranged before the object of A3, as shown in FIG. 26D. The controller 110 then may rearrange objects arranged after the object of A3 to which the emphasis effect is applied. For example, the controller 110 may rearrange objects of A4 to C1 arranged after the object of A3. More specifically, as shown in FIG. 26D, the controller 110 may rearrange the objects of A4 to C1 by shifting an object of A4 to B1, B1 to B2, B2 to C1, B3 to C2, B4 to C3, and C1 to C4.

In another example, as shown in FIG. 26E, the at least one object to which the emphasis effect is applied is an object arranged in cell A4. The object of A4 is expanded in size to occupy adjacent columns B and C, at step S230. Thus, the controller 110 may fix the order of objects arranged before the object of A4 to which the emphasis effect is applied. For example, the controller 110 may fix the order of objects of A1 and A3 arranged before the object of A4, as shown in FIG. 26E. The controller 110 then may rearrange objects arranged after the object of A4 to which the emphasis effect is applied. For example, the controller 110 may rearrange objects of B1 to B4 arranged after the object of A4. For example, as shown in FIG. 26E, the controller 110 may rearrange the objects of B1 to B4 by shifting an object of B1 to B3, B2 to B4, B3 to C3, and B4 to C4. The controller 110 may leave the cell A4 blank.

In another example, as shown in FIG. 26F, the at least one object to which the emphasis effect is applied is an object arranged in cell B1. The object of B1 to which the emphasis effect is applied is expanded in size to occupy adjacent row 2 and column C, at step S230. Thus, the controller 110 may fix the order of objects arranged before the object of B1 to which the emphasis effect is applied. For example, the controller 110 may fix the order of objects of A1 to A4 arranged before the object of B1, as shown in FIG. 26F. The controller 110 then may rearrange objects arranged after the object of B1 to which the emphasis effect is applied. For example, the controller 110 may rearrange objects of B2 to C1 arranged after the object of B1. For example, as shown in FIG. 26F, the controller 110 may rearrange the objects of B2 to C1 by shifting an object of B2 to B3, B3 to B4, B4 to C3, and C1 to C4.

In another example, as shown in FIG. 26G, the at least one object to which the emphasis effect is applied is an object arranged in cell B2. The object of B2 to which the emphasis effect is applied is expanded in size to occupy adjacent row 3 and column C, at step S230. Thus, the controller 110 may fix the order of objects arranged before the object of B2 to which the emphasis effect is applied. For example, the controller 110 may fix the order of objects of A1 to B1 arranged before the object of B2, as shown in FIG. 26G. The controller 110 then may rearrange objects arranged after the object of B2 to which the emphasis effect is applied. For example, the controller 110 may rearrange objects of B3 to C1 arranged after the object of B2. For example, as shown in FIG. 26G, the controller 110 may rearrange the objects of B3 to C1 by shifting an object of B3 to B4, B4 to C1, and C1 to C4.

As such, a plurality of objects may be displayed with order of objects before at least one object for which an emphasis effect is applied being fixed and order of objects after the at least one object being rearranged.

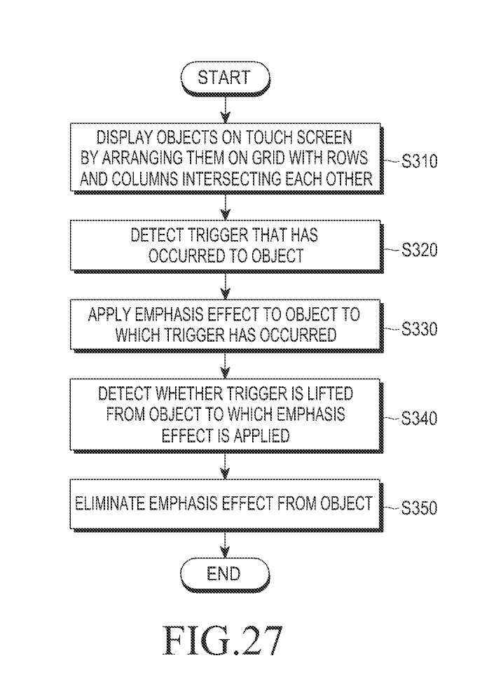

FIG. 27 is a flowchart illustrating a method of controlling a mobile device to perform trigger-based object display according to an exemplary embodiment of the present invention.

Referring to FIG. 27, in the exemplary embodiment of the method of controlling the mobile device 100 to perform trigger-based object display, a plurality of objects are first displayed on the touch screen 190 as being arranged on a grid formed with rows and columns, at step S310. The controller 110 of the mobile device 100 may display the plurality of objects on the touch screen 190 by arranging them on the grid. The grid may be formed with rows and columns passing across each other. At this time, the grid may be formed with rows and columns intersecting at right angles.

The controller 110 may display the plurality of objects on the touch screen 190 by arranging them on the grid formed with rows and columns intersecting each other. The plurality of objects may be content and may include at least one of images, text, and videos. The plurality of objects may also be icons, widgets, thumbnails, or the like.

A trigger that has occurred to any of the plurality of objects may be detected, at step S320. For example, the controller 110 may detect a trigger that has occurred to any of the plurality of objects. The trigger may be a map trigger, a favorites trigger, a share setting trigger, a comment write trigger, an entry path trigger, or an event trigger for any of the plurality of objects.

For example, the controller 110 may detect the map trigger that has occurred to any of the plurality of objects. More specifically, the controller 110 may have a trigger occur for any of the plurality of objects if a location where the object was captured is the same as where the mobile device 100 is at present. The trigger may be called the ‘map trigger’. The controller 110 may detect the map trigger that has occurred to any of the plurality of objects.

At step S330, an emphasis effect is applied to at least one object to which the trigger has occurred. The emphasis effect refers to any one of expanding the size of the at least one object, changing the color of the at least one object, and applying a predefined effect to the at least one object. In other words, the controller 110 may display the at least one object to which the trigger has occurred, which is detected at step S320, by applying the emphasis effect to the at least one object. For example, the controller 110 may display the at least one object to which the trigger has occurred by expanding the size of the at least one object. In this case, the controller 110 may expand the size to occupy an adjacent row and/or column.

Thereafter, it is detected whether the trigger that has occurred to the at least one object to which the emphasis effect is applied is lifted, at step S340. For example, the controller 110 may detect that the map trigger that has occurred to any of the plurality of objects at step S320 is lifted. More specifically, the controller 110 may lift a trigger for any of the plurality of objects if the location where the object was captured is not the same any more as where the mobile device 100 is at present. The controller 110 may detect that the map trigger for any of the plurality of objects is lifted.

At step S350, the controller 110 may lift the emphasis effect that has been applied to any of the plurality of objects. In other words, the controller 110 may lift the emphasis effect on the object to which the trigger was occurred. For example, the controller 110 may lift the emphasis effect that has expanded the size of the object to which the trigger was occurred. In other words, the controller 110 may reduce the expanded size of the object to which the trigger was occurred.

According to an exemplary embodiment of the present invention, the emphasis effect may be eliminated by detecting that the trigger for the at least one object has been lifted.

The exemplary embodiment of the present invention gives an advantage of detecting a trigger that has occurred to any one of a plurality of objects.

It will be appreciated that the exemplary embodiments of the present invention may be implemented in a form of hardware, software, or a combination of hardware and software. The software may be stored as program instructions or computer readable codes executable on the processor on a computer-readable medium. Examples of the computer readable recording medium include magnetic storage media (e.g., a ROM, floppy disks, hard disks, and the like), and optical recording media (e.g., Compact Disc (CD)-ROMs, or Digital Video Discs (DVDs)). The computer readable recording medium can also be distributed over network coupled computer systems so that the computer readable code is stored and executed in a distributed fashion. This media can be read by the computer, stored in the memory, and executed by the processor. The memory included in the power transmitter or the power receiver may be an example of the computer readable recording medium suitable for storing a program or programs having instructions that implement the exemplary embodiments of the present invention. The present invention may be implemented by a program having codes for embodying the apparatus and a method described in claims, the program being stored in a machine (or computer) readable storage medium. The program may be electronically carried on any medium, such as communication signals transferred via a wired or a wireless connection, and the exemplary embodiments of present invention suitably includes its equivalent.

The mobile device may receive the program from a program provider wired/wirelessly connected thereto, and store the program. The program provider may include a memory for storing programs having instructions to perform the exemplary embodiments of the present invention, information necessary for the exemplary embodiments of the present invention, and the like, a communication unit for wired/wirelessly communicating with the mobile device, and a controller for sending the program to the transceiver at the request of the mobile device or automatically.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for controlling a mobile device to perform trigger-based object display, the method comprising:
displaying a plurality of objects on a touch screen by arranging the plurality of objects on a grid with rows and columns intersecting each other;
detecting a trigger occurring to at least one of the plurality of objects; and
applying an emphasis effect to the at least one of the plurality of objects to which the trigger has occurred.

2. The method of claim 1, wherein the displaying of the plurality of objects comprises arranging the plurality of objects on the grid in a predefined sequence.

3. The method of claim 2, wherein the predefined sequence of arranging the plurality of objects on the grid is from top-left to bottom-right.

4. The method of claim 2, wherein the plurality of objects are displayed by arranging the plurality of objects on the grid in a predefined sequence based on attributes of the plurality of objects.

5. The method of claim 4, wherein the attributes of the plurality of objects comprise at least one of points in time when the plurality of objects are stored, alphabetical order of titles, data types, and data sizes of the plurality of objects.

6. The method of claim 1, wherein the trigger comprises at least one of a map trigger, a favorites trigger, a share setting trigger, a comment write trigger, an entry path trigger, and an event trigger.

7. The method of claim 1, wherein the at least one of the plurality of objects are expanded a size of the at least one object to occupy an adjacent row or column if the emphasis effect is expanding a size of the at least one object to which the trigger has occurred.

8. The method of claim 1, further comprising:
displaying the plurality of objects with order of objects arranged before the at least one object to which the emphasis effect is applied being fixed and with order of objects arranged after the at least one object being rearranged.

9. The method of claim 1, wherein the emphasis effect comprises at least one of expanding a size of the at least one object to which the trigger has occurred, changing color of the at least one object, applying an animation effect to the at least one object, and applying an outlining effect to the at least one object.

10. The method of claim 1, further comprising:
detecting whether the trigger that has occurred to the at least one object to which the emphasis effect is applied is lifted; and
eliminating the emphasis effect from the at least one object.

11. A mobile device for performing trigger-based object display, the mobile device comprising:
a touch screen configured to display a plurality of objects by arranging the plurality of objects on a grid with rows and columns intersecting each other; and
a controller configured to detect a trigger occurring to at least one of the plurality of objects, and configured to apply an emphasis effect to the at least one of the plurality of objects to which the trigger has occurred.

12. The mobile device of claim 11, wherein the plurality of objects are displayed by arranging the plurality of objects on the grid in a predefined sequence.

13. The mobile device of claim 12, wherein the predefined sequence of arranging the plurality of objects on the grid is from top-left to bottom-right.

14. The mobile device of claim 12, wherein the controller displays the plurality of objects by arranging the plurality of objects on the grid in a predefined sequence based on attributes of the plurality of objects.

15. The mobile device of claim 14, wherein the attributes of the plurality of objects comprise at least one of points in time when the plurality of objects are stored, alphabetical order of titles, data types, and data sizes of the plurality of objects.

16. The mobile device of claim 11, wherein the trigger comprises at least one of a map trigger, a favorites trigger, a share setting trigger, a comment write trigger, an entry path trigger, and an event trigger.

17. The mobile device of claim 11, wherein the at least one of the plurality of objects are expanded a size of the at least one object to occupy an adjacent row or column if the emphasis effect is expanding the size of the at least one object to which the trigger has occurred.

18. The mobile device of claim 11, wherein the controller displays the plurality of objects with order of objects arranged before the at least one object to which the emphasis effect is applied being fixed and with order of objects arranged after the at least one object being rearranged.

19. The mobile device of claim 11, wherein the emphasis effect comprises at least one of expanding a size of the at least one object to which the trigger has occurred, changing color of the at least one object, applying an animation effect to the at least one object, and applying an outlining effect to the at least one object.

20. The mobile device of claim 11, wherein the controller detects whether the trigger for the at least one object to which the emphasis effect is applied is lifted, and eliminates the emphasis effect from the at least one object.

21. A non-transitory computer-readable storage medium storing instructions that, when executed, cause at least one processor to perform the method of claim 1.
